(19) United States
(12) Patent Application Publication
(10) Pub. No.: US 2011/0233306 A1
(43) Pub. Date: Sep. 29, 2011

(54) POWDER SPRAY HEAD

(76) Inventor: Chuan-Wei Ko, Chung-Li (TW)

(21) Appl. No.: 12/748,394

(22) Filed: Mar. 27, 2010

(51) Int. Cl. B05B 1/00

(52) U.S. Cl. 239/337

(57) ABSTRACT

A powder spray head is disclosed having a spray head body, a connection portion formed integral with and perpendicularly extended from the periphery of the spray head body for the connection of an inflation bulb, a passage transversely extending through the spray head body and the connection portion, a bottom mounting recess located on the bottom side of the spray head body and mountable to a bottleneck of a bottle, and a locating hole connected between the bottom mounting recess and the passage for the connection of a dip tube.

### BACKGROUND OF THE INVENTION

1. Field of the Invention

The present invention relates to sprayers and more particularly, to a powder spray head for applying powder material, which prevents air leakage and facilitates smoothly application of a powder material.

2. Description of the Related Art

Perfume powder for hair, face or body application may be contained in a bottle or spray bottle. However, when using a bottled perfume powder, it is difficult to control the applied amount of perfume powder. The most commonly used design of perfume powder sprayer comprises a powder bottle, an accumulator fastened to the top side of the powder bottle and holding a dip tube in the powder bottle, a nozzle tube fastened to the accumulator at one side, a connection tube fastened to the accumulator at an opposite side and an inflation bulb connected to the connection tube. When the user compresses the inflation bulb to force the inside air out of the inflation bulb through the accumulator and the nozzle tube, a vacuum suction force is produced in the accumulator subject to a venturi action, causing the dip tube to suck the perfume powder from the powder bottle into the accumulator for carrying by the forced air out of the nozzle tube in a mist for application.

This design of perfume powder sprayer is still not satisfactory in function and has drawbacks as follows:

1. When compressing the inflation bulb, the forced air passes through the connection tube before entering the accumulation chamber in the accumulator. Air leakage may occur in case of improper installation of the connection tube in the accumulator or after a long use of the perfume powder sprayer. When this problem occurs, the amount of forced air will be insufficient, causing the perfume powder being sucked into the accumulation chamber unable to be fully driven out of the nozzle tube.

2. The dip tube is kept in communication with the accumulation chamber in the accumulator through a cap. When the dip tube sucks in the perfume powder, the perfume powder that entered the dip tube may be not carried into the accumulation chamber for carrying by the forced air out of the nozzle tube due to air leakage between the dip tube and the cap.

### SUMMARY OF THE INVENTION

The present invention has been accomplished under the circumstances in view. It is one object of the present invention to provide a powder spray head, which is made in a single piece, avoiding air leakage and facilitating smooth application of a powder material. It is another object of the present invention to provide a powder spray head, which has a single-piece design, facilitating fabrication. It is still another object of the present invention to provide a powder spray head, which allows direction connection of a dip tube, facilitating direct mixing of a powder material with forced air and preventing air leakage.

To achieve these and other objects of the present invention, a powder spray head comprises a spray head body, a connection portion formed integral with and perpendicularly extended from the periphery of the spray head body for the connection of an inflation bulb, a passage transversely extending through the spray head body and the connection portion, a bottom mounting recess located on a bottom side of the spray head body and mountable to a bottleneck of a bottle, and a locating hole connected between the bottom mounting recess and the passage for the connection of a dip tube.

### BRIEF DESCRIPTION OF THE DRAWINGS

FIG. 1 is an elevational view of a powder spray head in accordance with the present invention.

FIG. 2 is another elevational view of the powder spray head in accordance with the present invention when viewed from another angle.

FIG. 3 is a sectional side view of the powder spray head in accordance with the present invention.

FIG. 4 is a schematic sectional view of the present invention, showing the powder spray head installed in a powder sprayer bottle.

FIG. 5 is a sectional elevation of the valve tube according to the present invention.

FIG. 6 is a cross-sectional view of the valve tube according to the present invention.

### DETAILED DESCRIPTION OF THE PREFERRED EMBODIMENT

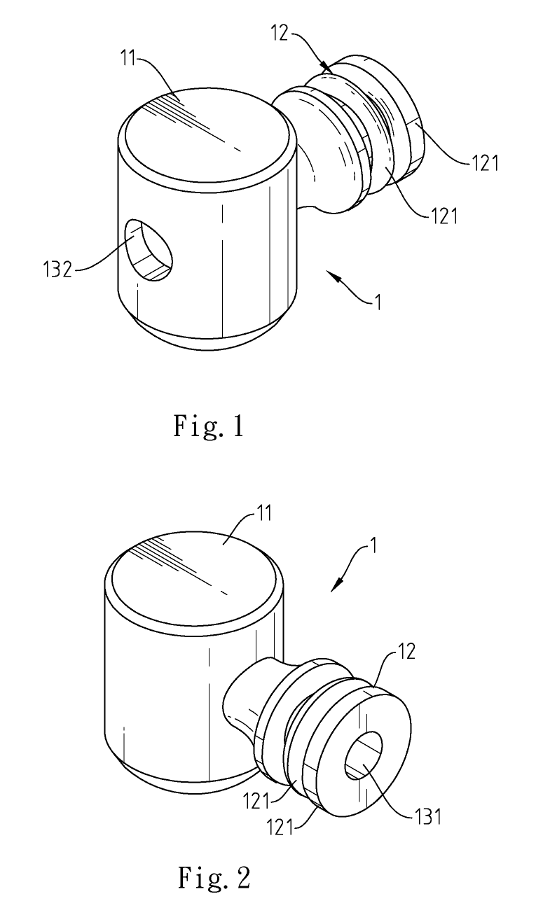

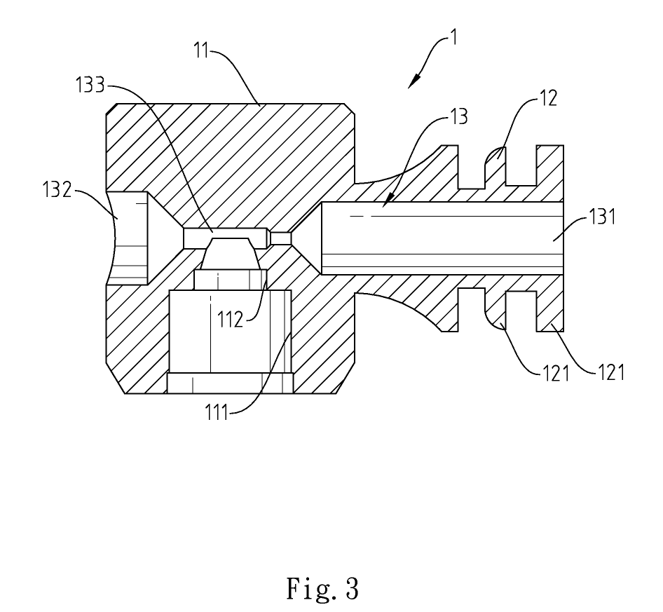

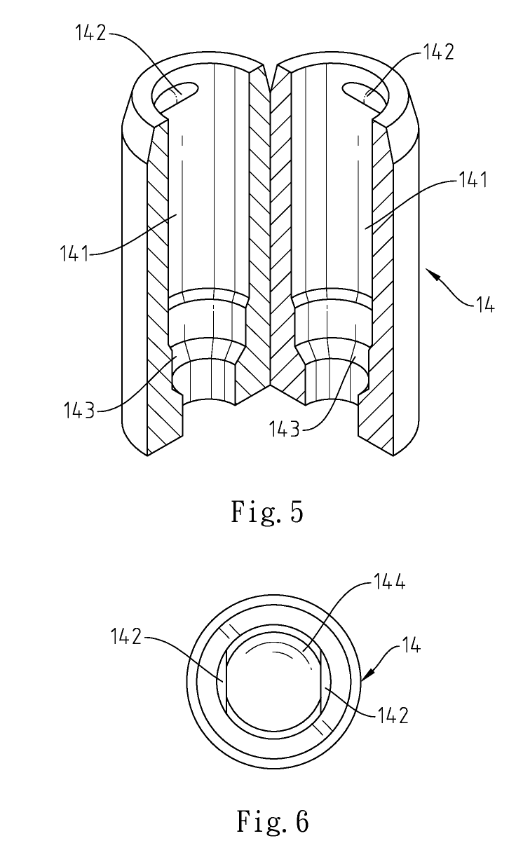

Referring to FIGS. 1-6, a powder spray head 1 in accordance with the present invention is shown comprising a spray head body 11, a connection portion 12 perpendicularly extended from the periphery of the spray head body 11, a passage 13 extending through the spray head body 11 and the connection portion 12, an air inlet 131 located on one end of the passage 13 at the connection portion 12, a powder-spray nozzle hole 132 located on the other end of the connection portion 12 remote from the air inlet 131, a mixing chamber 133 formed in the passage 13 between the air inlet 131 and the powder-spray nozzle hole 132, a valve tube 14 mounted in the air inlet 131, a bottom mounting recess 111 located on the bottom side of the spray head body 11, and a locating hole 112 connected between the bottom mounting recess 111 and the mixing chamber 133. The connection portion 12 is formed integral with the periphery of the spray head body 11, having a plurality of retaining ribs 121 extending around the periphery thereof. The valve tube 14 has an axial air hole 141 extending through the two distal ends thereof, a stop flange 142 protruded from the inside wall near one end of the axial air hole 141 and a constricted portion 143 disposed at the other end of the axial air hole 141. Further, the valve tube 14 holds a ball 144 therein. The ball 144 is movably accommodated in the axial air hole 141 between the stop flange 142 and the constricted portion 143.

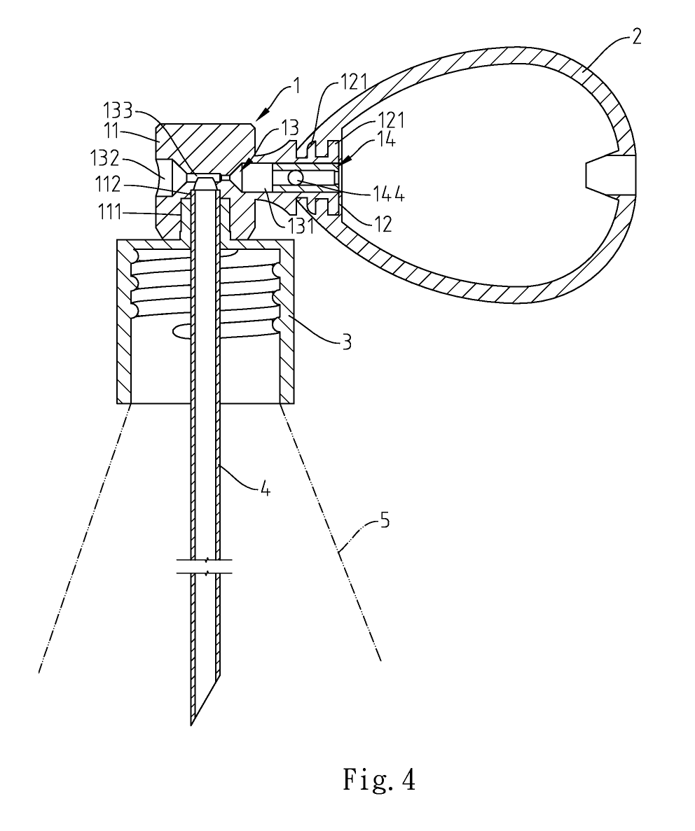

Referring to FIGS. 4-6 again, when using the powder spray head 1, connect an inflation bulb 2 to the retaining ribs 121 of the connection portion 12, and then connect the bottom mounting recess 111 to a bottle cap 3, and then tightly insert a dip tube 4 through the bottle cap 3 into the locating hole 112 in communication with the mixing chamber 133, and then fasten the bottle cap 3 to a powder bottle 5. Thus, a powder spray bottle is assembled.

During application, compress the inflation bulb 2 to force the internal air out of the inflation bulb 2 through the valve tube 14 into the air passage 13. At this time, the ball 144 is forced away from the constricted portion 143 for letting the compressed air pass through the valve tube 14 toward the mixing chamber 133 and the powder-spray nozzle hole 132.

When the compressed air is being forced out of the power-spray nozzle hole 132, a suction force is produced in between the mixing chamber 133 and the locating hole 112 subject to the venturi action, causing the contained powder to be sucked from the powder bottle 5 through the dip tube 4 into the mixing chamber 133 and then carried by the compressed air out of the power-spray nozzle hole 132 in a mist for application. When the user releases the hand from the inflation bulb 2, the ball 144 is sucked backwards to stop against the constricted portion 143, prohibiting the powder from getting into the inflation bulb 2. At this time, the inflation bulb 2 returns to its former shape for a next operation.

In conclusion, the invention provides a powder spray head 1, which has advantages and features as follows:

1. The spray head body 11 and the connection portion 12 are integrally made in a single piece. After connection of the inflation bulb 2 to the connection portion 12 and compression of the inflation bulb 2 by the user, compressed air goes directly out of the inflation bulb 2 to the passage 13, avoiding air leakage and uneven mixing of compressed air with the powder material. Thus, the invention simplifies the fabrication of the powder spray head and greatly reduces its manufacturing cost.

2. The locating hole 112 connected between the bottom mounting recess 111 and the mixing chamber 133 in the air passage 13. After connection of the dip tube 4 to the locating hole 112, the dip tube 4 can guide the powder material from the powder bottle 5 to the mixing chamber 133 directly, assuring positive supply of the powder material.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A powder spray head, comprising a spray head body, a connection portion formed integral with and perpendicularly extended from the periphery of said spray head body for the connection of an inflation bulb, a passage transversely extending through said spray head body and said connection portion, a bottom mounting recess located on a bottom side of said spray head body and mountable to a bottleneck of a bottle, and a locating hole connected between said bottom mounting recess and said passage for the connection of a dip tube.

2. The powder spray head as claimed in claim 1, wherein said connection portion has a plurality of retaining ribs extending around the periphery thereof for securing an inflation bulb.

3. The powder spray head as claimed in claim 1, wherein said passage has an air inlet located on one end thereof in said connection portion, a powder-spray nozzle hole located on an opposite end thereof, and a mixing chamber connected in between said air inlet and said powder-spray nozzle hole.
